(19) United States
(12) Patent Application Publication
(10) Pub. No.: US 2019/0237215 A1
(43) Pub. Date: Aug. 1, 2019

(54) Insulated Wire

(71) Applicant: Hitachi Metals, Ltd., Tokyo (JP)

(72) Inventors: Akira SETOGAWA, Tokyo (JP); Akinari NAKAYAMA, Tokyo (JP)

(21) Appl. No.: 16/205,007

(22) Filed: Nov. 29, 2018

(30) Foreign Application Priority Data
Jan. 26, 2018 (JP) 2018-011180

(51) Int. Cl. H01B 7/02; H01B 7/04

(52) U.S. Cl. CPC H01B 7/0241; H01B 7/04; H01B 7/0216

(57) ABSTRACT

Bendability of an insulated wire having a separator layer interposed between a conductor and an insulating layer is improved. The insulated wire has a conductor; a separator layer formed of separator tapes wound on the conductor; and an insulating layer arranged on a periphery of the separator layer. The separator tape is spirally wound so that width-directional parts of the separator tapes are overlapped with one another, and a plurality of overlapped portions at which the width-directional parts of the separator tapes are overlapped with one another to be three- or more-layered exist in a longitudinal direction of the conductor.

### CROSS-REFERENCE TO RELATED APPLICATION

The present application claims priority from Japanese Patent Application No. 2018-011180 filed on Jan. 26, 2018, the content of which is hereby incorporated by reference into this application.

### TECHNICAL FIELD OF THE INVENTION

The present invention relates to an insulated wire having a conductor and an insulating layer arranged on a periphery of the conductor.

### BACKGROUND OF THE INVENTION

Lately, various electric wires for power supply, communication, etc., have been used in various fields. As one of such electric wires, an insulated wire having a conductor and an insulating layer arranged on a periphery of the conductor has been known. In such an insulated wire, a separator layer is provided between the conductor and the insulating layer in some cases. Specifically, before the insulating layer is formed on the periphery of the conductor, a tape-form (belt-form) separator (may be referred to as “separator tape” below) is spirally wound on the conductor to wrap the conductor. After that, the separator tape that has been wound on the conductor is exposed to high-pressure steam, and is chemically cross-linked to form the separator layer. This separator layer plays a role of preventing a resin material making up the insulating layer from infiltrating into a gap between a plurality of wires making up the conductor.

The separator layer playing the above-described role is required to cover the conductor so as not cause any gap. Accordingly, when the separator tapes are wound on the conductor, the separator tapes are partially overlapped with one another. That is, a width-directional part of the separator tape covers a width-directional part of the already-wound separator tape, and a remaining part thereof is wound on the conductor so as to cover the conductor.

Here, as long as the separator tapes are even slightly overlapped, the separator layer that covers the conductor without any gap can be formed. Meanwhile, the larger an overlapped area among the separator tapes is, the larger a length of the separator tape required for making up the separator layer is, and therefore, a cost and time required for manufacturing the insulated wire becomes larger and longer. Accordingly, from the viewpoint of reducing the manufacturing cost, shortening the manufacturing time, etc., the fact that it is preferable to reduce the overlapped area among the separator tapes as small as possible is common knowledge in the technical field.

### SUMMARY OF THE INVENTION

Generally, an insulated wire having the separator layer has worse bendability than that of an insulated wire not having the separator layer. In the diligent studies on the improvement of the bendability of the insulated wire having the separator layer, the inventors of the present application have found out that a degree of the overlapped area among the separator tapes making up the separator layer affects the bendability of the insulated wire. Then, the inventors of the present application have further studied the improvement of the bendability of the insulated wire having the separator layer based on the above-described founding, and have led to the completion of the invention of the present application.

An object of the present invention is to improve the bendability of the insulated wire having the separator layer interposed between the conductor and the insulating layer.

The insulated wire of the present invention has a conductor, a separator layer formed of separator tapes wound on the conductor, and an insulating layer arranged on a periphery of the separator layer. The separator tapes are spirally wound so that width-directional parts of the separator tapes are overlapped with one another, and a plurality of overlapped portions at which the width-directional parts of the separator tapes are overlapped with one another to be three- or more-layered exist in a longitudinal direction of the conductor.

In an aspect of the present invention, the separator tapes are spirally wound so as to be overlapped with one another in 55% or more of the entire width.

In another aspect of the present invention, a plurality of the overlapped portions exist at a certain interval along the longitudinal direction of the conductor.

In still another aspect of the present invention, a plurality of the overlapped portions exist continuously along the longitudinal direction of the conductor.

According to the present invention, the bendability of the insulated wire having the separator layer interposed between the conductor and the insulating layer can be improved.

### BRIEF DESCRIPTIONS OF THE DRAWINGS

FIG. 1 is a diagram showing an entire structure of an insulated wire;

FIG. 2 is a diagram showing an example of an overlapping degree among separator tapes in a vertical cross-sectional surface of the insulated wire;

FIG. 3 is a diagram showing an overlapping degree among separator tapes at an overlapped portion so as to expand the overlapped portion;

FIG. 4 is a diagram showing another example of the overlapping degree among the separator tapes in the vertical cross-sectional surface of the insulated wire; and

FIG. 5 is a diagram showing still another example of the overlapping degree among the separator tapes in the vertical cross-sectional surface of the insulated wire.

### DESCRIPTIONS OF THE PREFERRED EMBODIMENTS

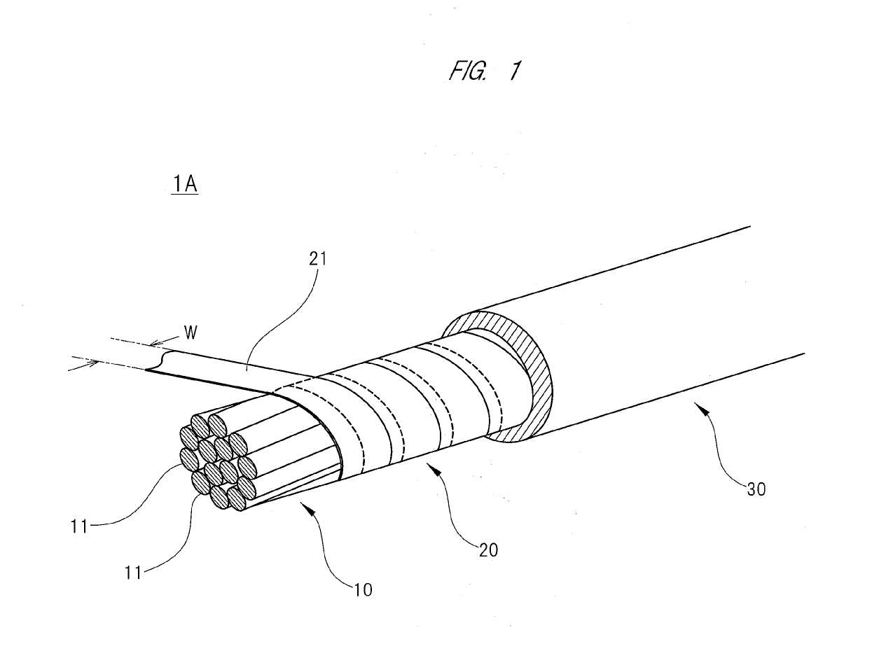

Next, one example of an embodiment of the insulated wire of the present invention will be described in detail with reference to drawings. As shown in FIG. 1, an insulated wire 1A according to the present embodiment has: a conductor 10, a separator layer 20 arranged on a periphery of the conductor 10, and an insulating layer 30 arranged on a periphery of the separator layer 20.

The conductor 10 is a stranded wire having a diameter of 2.0 mm that is a bunch stranded wire formed of a plurality of wires 11. Each of the wires 11 in the present embodiment is a soft-drawn copper wire having a diameter of 0.19 mm. However, the wire 11 is not limited to the soft-drawn copper wire. For example, the conductor 10 can be formed by using other wires such as a hard-drawn copper wire, a tin-plated soft-drawn copper wire, and a tin-plated hard-drawn copper wire. And, a stranding method of the wire 11 is not limited to the bunch stranding method, either. For example, a concentric-lay stranding method or a rope-lay stranding method may be applicable.

The shown separator layer 20 is formed of separator tapes 21 wound on the conductor 10. The entire width (W) of the separator tape 21 in the present embodiment is 80 mm, and a thickness thereof is 0.1 mm. As shown in the drawings, the separator tapes 21 are spirally wound so that width-directional parts of the separator tapes are vertically overlapped with one another. In other words, the separator tapes 21 are horizontally wound at a predetermined lay pitch on the conductor 10.

A material of the separator tape 21 in the present embodiment is PET (Polyethylene terephthalate). However, the material of the separator tape 21 is not limited to PET. As another material of the separator tape 21, nylon and others are cited.

The insulating layer 30 is an insulating resin layer that is extruded and molded onto a periphery of the separator layer 20. The insulating layer 30 in the present embodiment is made of EPDM (ethylene-propylene rubber), and has a thickness of 8.0 mm. However, a material of the insulating layer 30 is not limited to EPDM. As one example of another material of the insulating layer 30, butyl rubber and others are cited.

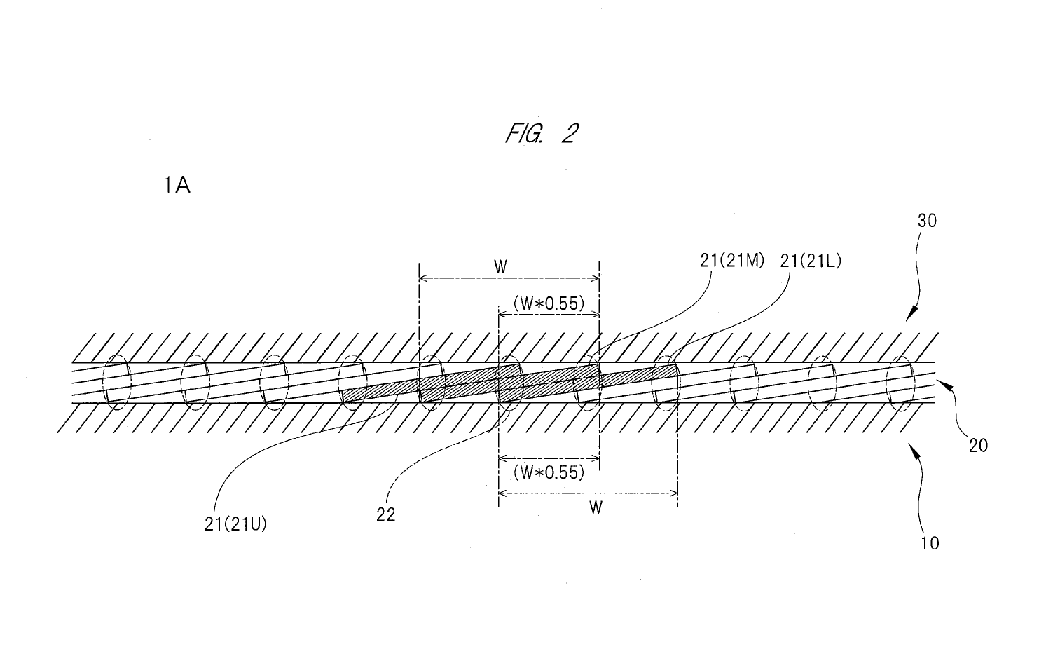

FIG. 2 is a cross-sectional view schematically showing the overlapping degree among the separator tapes 21 in a vertical cross-sectional surface of the insulated wire LA. As shown in FIG. 2, the separator tapes 21 are spirally wound so as to be overlapped with one another in 55% (44 mm) of the entire width (W). As a result, a plurality of overlapped portions 22 at which (three) separator tapes 21 are vertically overlapped with one another to be three-layered exits in the longitudinal direction of the conductor (in a right-and-left direction on a drawing sheet). These overlapped portions 22 exist at a certain interval (discontinuously) along the longitudinal direction of the conductor 10. In FIG. 2, note that hatching is added to each cross-sectional surface of only some separator tapes 21 for convenience in the drawing.

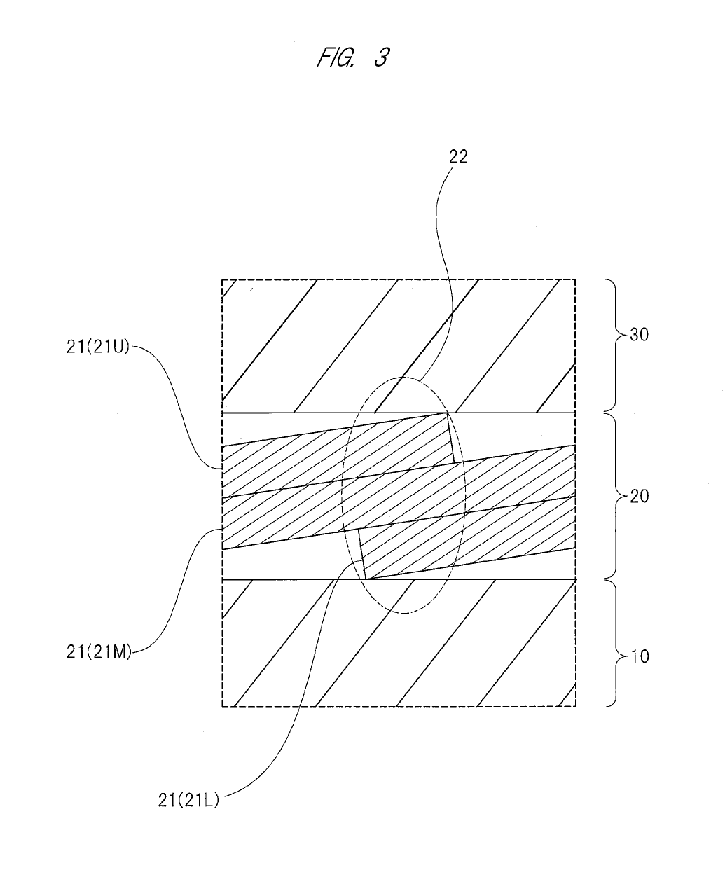

As shown in FIG. 3, at each overlapped portion 22 at which the separator tapes 21 are overlapped with one another to be three-layered, a lower separator tape 21 (referred to as “lower separator tape 21L” below) is interposed between a middle separator tape 21 (referred to as “middle separator tape 21M” below) and the conductor 10, and an upper separator tape 21 (referred to as “upper separator tape 21U” below) is interposed between the middle separator tape 21M and the insulating layer 30. That is, at each overlapped portion 22, the middle separator tape 21M is not in contact with neither the conductor 10 nor the insulating layer 30. In other words, at each overlapped portion 22, the middle separator tape 21M is in contact with the lower separator tape 21L or the upper separator tape 21U.

In this case, a lot of irregular surfaces exist on a surface of the conductor 10 that is the stranded wire. Therefore, slipperiness on an interface between the conductor 10 and the separator tape 21 is lower than slipperiness on an interface between the separator tapes 21. And, a friction coefficient of an interface between the separator tape 21 and the insulating layer 30 that has been extruded and molded on the separator tape is larger than a friction coefficient of an interface between the separator tapes 21. In other words, slipperiness on an interface between two overlapped separator tapes 21 is higher than the slipperiness on the interface between the conductor 10 and the separator tape 21 and the slipperiness on the interface between the separator tape 21 and the insulating layer 30. Therefore, each overlapped portion 22 at which the separator tapes 21 are vertically overlapped with one another to be three-layered has higher flexibility than those of other portions.

As described above, along the longitudinal direction, the insulated wire 1A according to the present embodiment has a plurality of the overlapped portions 22 having the higher flexibility than those of other portions, and has excellent bendability as a whole.

In FIGS. 2 and 3, note that the gap exists between the separator tape 21 (separator layer 20) and the conductor 10 and between the separator tape 21 (separator layer 20) and the insulating layer 30. However, practically, a substantial gap does not exist therebetween. For example, a region of a back surface of the middle separator tape 21M, the region being not overlapped with a front surface of the lower separator tape 21L, is tightly in contact with the conductor 10. A region of a front surface of the middle separator tape 21M, the region being not overlapped with a back surface of the upper separator tape 21U, is tightly in contact with the insulating layer 30.

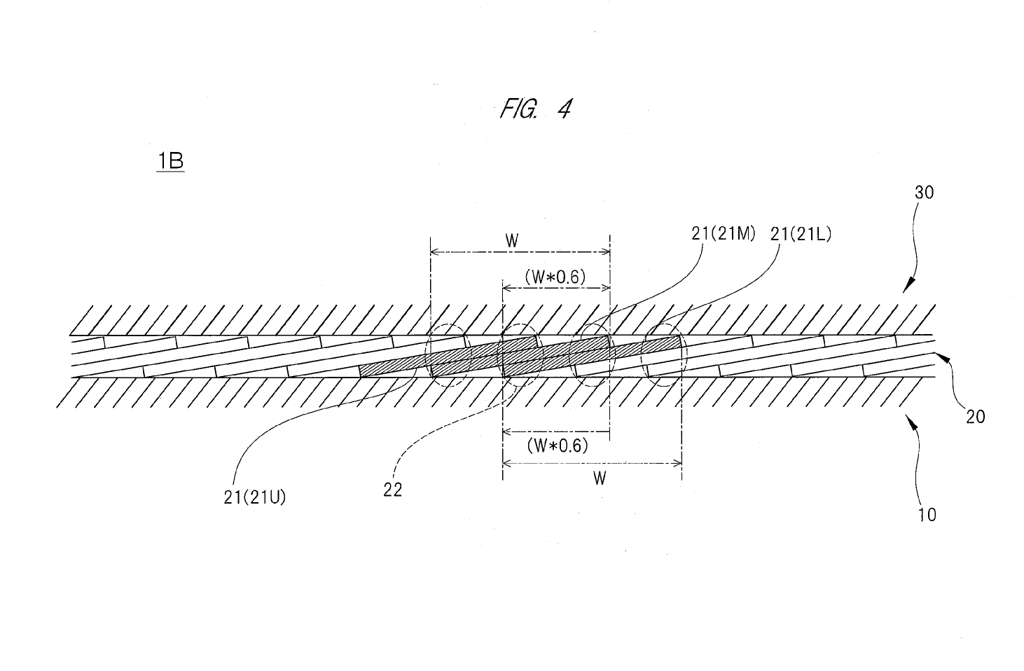

From the above description, it can be understood that the larger the overlapped area at each overlapped portion between the separator tapes 21 is, the more the bendability is improved. For example, as shown in FIG. 4, an insulated wire 1B having the separator tapes 21 that are wound so as to be vertically overlapped with one another in 60% (48 mm) of the entire width (W) shows higher bendability than that of the insulated wire 1A according to the present embodiment.

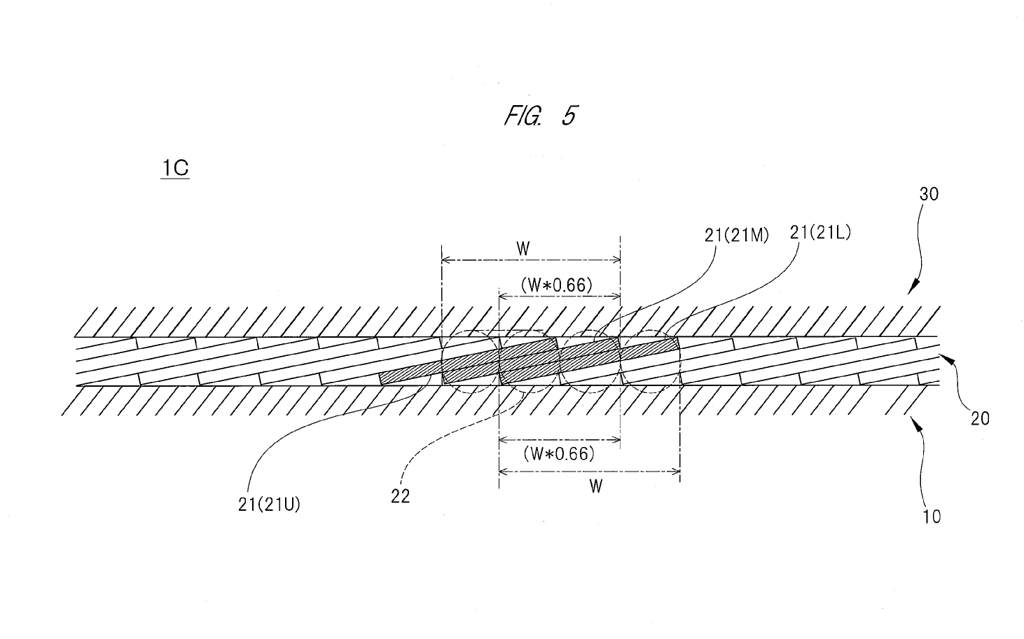

As shown in FIG. 5, an insulated wire 1C having the separator tapes 21 that are wound so as to be vertically overlapped with one another in 66% (52.8 mm) of the entire width (W) shows much higher bendability than that of the insulated wire 1B shown in FIG. 4. When the separator tapes 21 are wound so as to be vertically overlapped with one another in 66% (52.8 mm) of the entire width (W), a plurality of overlapped portions 22 continuously exist along the longitudinal direction of the conductor 10. Besides, when an overlapping ratio (that is a ratio of the overlapped portion 22 with respect to the entire width of the separator tape 21) is larger than 66% of the entire width (W), the number of layers of the separator tapes 21 at each overlapped portion 22 is equal to or larger than four (four or more separator tapes). In FIGS. 4 and 5, note that hatching is added to each cross-sectional surface of only some separator tapes 21 for convenience in the drawing.

Next, results of a test for confirming effects of the present invention will be described. In this test, six insulated wires “a” to “f” having the common configuration to one another except that the overlapping ratio of the separator tape is different were prepared, and the bendability of each of them was determined. All the prepared six insulated wires “a” to “f” were formed to have the same length (60 cm) as one another. While 10 cm of one end of each insulated wire was fixed onto a flat stand, 50 cm of the other end was floated in air, and then, the other end was hung with a weight of 600 g. Under such a condition, a vertical distance from a surface of the stand to the end (tip) of the insulated wire, the end being hung with the weight, was measured. When this distance is smaller than 5 cm, a result was determined as “χ”. When this distance is equal to or larger than 5 cm and smaller than 10 cm, a result was determined as “Δ”. When this distance is equal to or larger than 10 cm and smaller than 15 cm, a result was determined as “◯”. When this distance is larger than 15 cm, a result was determined as “⊚”. The configurations of the prepared insulated wires “a” to “f” and the determined results are as shown in a table 1.

TABLE 1

| | | Number of overlapped | | |
|---|---|---|---|---|
| | Overlapping | tapes at each | Overlapping | |
| | ratio | overlapped portion | continuousness | Bendability |
| a | 35% | 2 | Continued | X |
| b | 50% | 2 | Continued | Δ |
| c | 55% | 3 | Discontinued | ◯ |
| d | 60% | 3 | Discontinued | ◯ |
| e | 66% | 3 | Continued | ◯ |
| f | 75% | 4 | Continued | ⊚ |

As a result of the above-described test, it has been confirmed that the favorable bendability can be obtained when the number of the overlapped separator tapes at each overlapped portion is equal to or larger than three. And, it has been confirmed that the favorable bendability can be further improved when the number of the overlapped separator tapes at each overlapped portion is equal to or larger than four.

The present invention is not limited to the foregoing embodiments and various modifications can be made within the scope of the present invention. And, all numerical values and dimensions described in the present specification are merely examples, and are not limited. For example, a width and a thickness of the separator tape can be properly changed.

The strand lay direction of the wire making up the conductor wire and the winding direction of the separator tape maybe the same as or opposite to each other. And, a sheath may be arranged on a periphery of the insulating layer.

1. An insulated wire comprising:
a conductor;
a separator layer formed of one separator tape wound on the conductor; and
an insulating layer arranged on a periphery of the separator layer,
wherein the one separator tape is spirally wound so that width-directional parts of the one separator tape are in contact with and overlapped with one another, and
a plurality of overlapped portions at which the width-directional parts of the one separator tape are overlapped with one another to be three- or more-layered exist in a longitudinal direction of the conductor.

2. An insulated wire comprising:
a conductor;
a separator layer formed of one separator tape wound on the conductor; and
an insulating layer arranged on a periphery of the separator layer,
wherein the one separator tape is spirally wound so that width-directional parts of the one separator tape are in contact with and overlapped with one another,
a plurality of overlapped portions at which the width-directional parts of the one separator tape are overlapped with one another to be three- or more-layered exist in a longitudinal direction of the conductor, and
the one separator tape is spirally wound so as to be in contact with and overlapped with one another in 55% or more of the entire width.

3. The insulated wire according to claim 1,
wherein a plurality of the overlapped portions exist at a certain interval along the longitudinal direction of the conductor.

4. The insulated wire according to claim 2,
wherein a plurality of the overlapped portions exist at a certain interval along the longitudinal direction of the conductor.

5. The insulated wire according to claim 1,
wherein a plurality of the overlapped portions exist continuously along the longitudinal direction of the conductor.

6. The insulated wire according to claim 2,
wherein a plurality of the overlapped portions exist continuously along the longitudinal direction of the conductor.
